(19) United States
(12) Patent Application Publication
(10) Pub. No.: US 2024/0088525 A1
(43) Pub. Date: Mar. 14, 2024

(54) MAGNETIC BATTERY CELL CONNECTION MECHANISM

(71) Applicant: DURACELL U.S. OPERATIONS, INC., Wilmington, DE (US)

(72) Inventor: Robert John Pavlinsky, Oxford, CT (US)

(21) Appl. No.: 18/512,694

(22) Filed: Nov. 17, 2023

Related U.S. Application Data
(62) Division of application No. 17/138,267, filed on Dec. 30, 2020, now Pat. No. 11,837,754.

(51) Int. Cl. H01M 50/51; H01M 10/42; H01M 50/503; H01M 50/548; H01R 13/62

(52) U.S. Cl. CPC H01M 50/51; H01M 10/425; H01M 50/503; H01M 50/548; H01R 13/6205

(57) ABSTRACT

A magnetic battery cell connection mechanism includes a first battery cell and a second battery cell. A first connector has a first body including a first electrical pathway. A first electrical contact is disposed on the first body and electrically connected to the first electrical pathway. A first magnet is connected to the first body, the first magnet being adapted to magnetically releasably secure the first body to a positive terminal of the first battery cell. A second connector has a second body including a second electrical pathway. A second electrical contact is disposed on the second body and electrically connected to the second electrical pathway. A second magnet is connected to the second body, the second magnet being adapted to magnetically releasably secure the second body to a negative terminal of the second battery cell. The first connector and the second connector are electrically connected to an electrical circuit.

### FIELD OF THE DISCLOSURE

The disclosure relates generally to battery indicators and, more specifically relates to a magnetic battery cell connection mechanism for providing power to an external load such as battery indicator.

### BACKGROUND

Electrochemical cells, or batteries, are commonly used as electrical energy sources. A battery contains a negative electrode, typically called the anode, and a positive electrode, typically called the cathode. The anode contains an electrochemically active anode material that can be oxidized. The cathode contains an electrochemically active cathode material that can be reduced. The electrochemically active anode material is capable of reducing the electrochemically active cathode material. A separator is disposed between the anode and the cathode. The battery components are disposed in a can, or housing, that is typically made from metal.

When a battery is used as an electrical energy source in an electronic device, electrical contact is made to the anode and the cathode, thereby completing a circuit that allows electrons to flow through the device, and which results in respective oxidation and reduction reactions that produce electrical power to the electronic device. An electrolyte is in contact with the anode, the cathode, and the separator. The electrolyte contains ions that flow through the separator between the anode and cathode to maintain charge balance throughout the battery during discharge.

There is a growing need for portable power for electronic devices such as toys; remote controls; audio devices; flashlights; digital cameras and peripheral photography equipment; electronic games; toothbrushes; radios; clocks, and other portable electronic devices. Consumers need to have power readily available for these electronic devices. Because batteries necessarily become depleted of power over time as they are used, consumers need to have access to spare batteries (and/or access to fully recharged rechargeable batteries). It is helpful for a consumer to know the power state of a battery currently in use so that the consumer can have quick access to the needed number of replacement batteries. Batteries come in common sizes, such as the AA, AAA, AAAA, C, and D battery sizes, that have fixed external dimensions and constrained internal volumes per ANSI standard.

Currently, some batteries include on-cell battery charge indicators to help a consumer determine when a battery is nearly depleted and in need of replacement. However, these current on-cell battery charge indicators are single use (i.e., attached to a single battery cell) and cumbersome (because typically two contact buttons must be simultaneously depressed to activate the indicator). Additionally, these on-cell battery indicators require removal of the battery from an electronic device (or package) in order to use the indicator.

### SUMMARY

According to a first aspect, a magnetic battery cell connection mechanism includes a first battery cell having a positive terminal and a negative terminal and a second battery cell having a positive terminal and a negative terminal. A first connector has a first body including a first electrical pathway. A first electrical contact is disposed on the first body and electrically connected to the first electrical pathway, the first electrical contact being adapted to allow electricity to pass from the positive terminal of the first battery cell to the first electrical pathway. A first magnet is connected to the first body, the first magnet being adapted to magnetically releasably secure the first body to the positive terminal of the first battery cell and to establish contact between the positive terminal of the first battery cell and the first electrical pathway. A second connector has a second body including a second electrical pathway. A second electrical contact is disposed on the second body and electrically connected to the second electrical pathway, the second electrical contact being adapted to allow electricity to pass from the negative terminal of the second battery cell to the second electrical pathway. A second magnet is connected to the second body, the second magnet being adapted to magnetically releasably secure the second body to the negative terminal of the second battery cell and to establish contact between the negative terminal of the second battery cell and the second electrical pathway. Each of the first connector and the second connector is electrically connected to an electrical circuit.

According to a second aspect, a magnetic battery cell connection mechanism includes a first battery cell having a positive terminal and a negative terminal. A first connector includes a first body including a first electrical pathway. A first electrical contact is disposed on the first body and electrically connected to the first electrical pathway, the first electrical contact being adapted to allow electricity to pass from the positive terminal of the first battery cell to the first electrical pathway. A first magnet is at least partially seated in the first electrical contact, the first magnet being adapted to magnetically releasably secure the first body to the positive terminal of the first battery cell. A second connector includes a second body including a second electrical pathway. A second electrical contact is disposed on the second body and electrically connected to the second electrical pathway, the second electrical contact being adapted to allow electricity to pass from the negative terminal of the first battery cell to the second electrical pathway. A second magnet is at least partially seated in the second electrical contact, the second magnet being adapted to magnetically releasably secure the second body to the negative terminal of the first battery cell. Each of the first connector and the second connector is electrically connected to an electrical circuit.

According to a third aspect, a magnetic battery cell connector includes a body having a first arm and a second arm that diverge away from one another, and an electrical pathway. An electrical contact is located proximate a terminal end of one of the first arm and the second arm. The electrical contact is electrically connected to the electrical pathway. The electrical contact is adapted to allow electricity to pass from a battery cell terminal to the first electrical pathway. A magnet is at least partially seated in the electrical contact. The magnet is adapted to magnetically releasably secure the first body to the battery cell.

In accordance with the teachings of the disclosure, any one or more of the foregoing aspects of a magnetic battery cell connection mechanism or a magnetic battery cell connector may further include any one or more of the following optional forms.

In some optional forms, the first magnet comprises the first electrical contact.

In other optional forms, the second magnet comprises the second electrical contact.

In yet other optional forms, one of the first body or the second body comprises a first arm and a second arm that diverge away from one another.

In yet other optional forms, the first and second arms form one of an arc-shape, a u-shape, and a v-shape.

In yet other optional forms, the first and second arms form an arc-shape and an inner radius of the arc-shape is substantially the same as a battery end cap of one of the first battery cell or the second battery cell.

In yet other optional forms, the first magnet is located on the first arm and the first electrical contact is located on the second arm.

In yet other optional forms, the first magnet and the first electrical contact are located on the same arm.

In yet other optional forms, the first electrical contact is cup-shaped and the first magnet is at least partially seated in the first electrical contact.

In yet other optional forms, a first contact plate is located proximate an end of the first arm and the first magnet is disposed on the first contact plate.

In yet other optional forms, a second contact plate is located proximate an end of the second arm.

In yet other optional forms, one of the first body or the second body comprises a printed circuit board (PCB).

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawings.

FIG. 1 is a perspective view of a battery cell connection mechanism installed two battery cells in an array of batteries in a battery cavity of a device and connected to a battery indicator module.

FIG. 2 is a perspective view of the battery cell connection mechanism of FIG. 1 installed on two different batteries in the array of batteries.

FIG. 3 is a perspective view of the battery cell connection mechanism of FIG. 1 installed on yet two other batteries in the array of batteries.

FIG. 4 is a perspective view of the battery cell connection mechanism of FIG. 1 installed on a single battery cell in the array of battery cells.

FIG. 5 is a close up end perspective view of the battery cell connection mechanism of FIG. 1 attached to two battery cells.

FIG. 6A is a perspective view of a non-contact side of a positive magnetic battery cell connector of the battery cell connection mechanism of FIG. 1.

FIG. 6B is a perspective view of a contact side of the positive magnetic battery cell connector of FIG. 6A.

FIG. 6C is an exploded perspective view of the non-contact side of the positive magnetic battery cell connector of FIG. 6A.

FIG. 7A is a perspective view of a non-contact side of a negative magnetic battery cell connector of the battery cell connection mechanism of FIG. 1.

FIG. 7B is a perspective view of a contact side of the negative magnetic battery cell connector of FIG. 7A.

FIG. 7C is an exploded perspective view of the non-contact side of the negative magnetic battery cell connector of FIG. 7C.

FIG. 8A is a close-up perspective view of an alternate embodiment of a positive magnetic battery cell connector.

FIG. 8B is a close-up perspective view of an alternate embodiment of a negative magnetic battery cell connector.

FIG. 9A is an exploded perspective view of a non-contact side of the positive magnetic battery cell connector of FIG. 8A.

FIG. 9B is an exploded perspective view of a contact side of the positive magnetic battery cell connector of FIG. 8A.

FIG. 10A is an exploded perspective view of a non-contact side of the negative magnetic battery cell connector of FIG. 8B.

FIG. 10B is an exploded perspective view of a contact side of the negative magnetic battery cell connector of FIG. 8B.

FIG. 11 is a plan view of the positive magnetic cell connector of FIG. 8A.

FIG. 12 is a plan view of an alternate embodiment of a positive magnetic battery cell connector.

### DETAILED DESCRIPTION OF THE INVENTION

Electrochemical cells, or batteries, may be primary or secondary. Primary batteries are meant to be discharged, e.g., to exhaustion, only once and then discarded. Primary batteries (or disposable batteries) are described, for example, in David Linden, Handbook of Batteries (4^{th} ed. 2011). Secondary batteries (or rechargeable batteries) are intended to be recharged and used over and over again. Secondary batteries may be discharged and recharged many times, e.g., more than fifty times, a hundred times, or more. Secondary batteries are described, for example, in David Linden, Handbook of Batteries (4^{th} ed. 2011). Accordingly, batteries may include various electrochemical couples and electrolyte combinations. Although the description and examples provided herein are generally directed towards primary alkaline electrochemical cells, or batteries, it should be appreciated that the invention applies to both primary and secondary batteries of aqueous, nonaqueous, ionic liquid, and solid state systems. Primary and secondary batteries of the aforementioned systems are thus within the scope of this application and the invention is not limited to any particular embodiment.

The magnetic battery cell connectors and magnetic battery cell connection mechanisms described herein advantageously provide a user adjustable voltage supply across a single battery cell or across a multiple battery cell stack to meet power requirements of an external load, such as a battery indicator. Moreover, the disclosed magnetic battery cell connectors and magnetic battery cell connection mechanisms advantageously are capable of delivering separate cell information or total cell array information to the battery indicator. The shape of the connectors advantageously fits within a battery cavity of a device without interference with the device contact terminals or neighboring battery cells and connects to battery cells without the need to remove the battery cells from the battery cavity. Additionally, the shape of the connectors allows the connector to rotate about the battery cell terminal without becoming disconnected from the battery cell terminal.

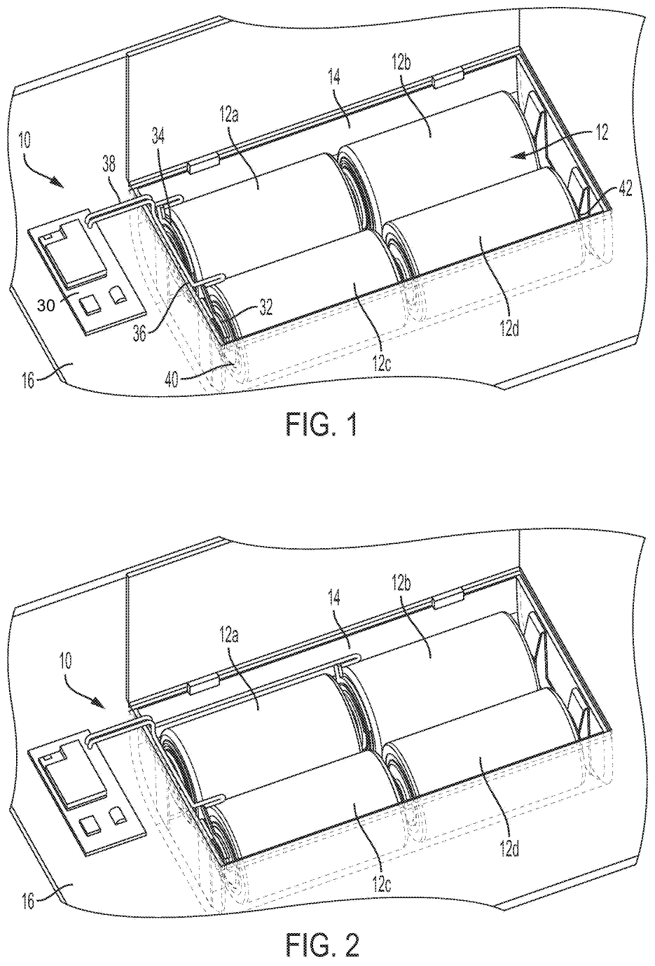

Referring now to FIGS. 1-3, a magnetic battery cell connection mechanism 10 is illustrated connected to a plurality of battery cells 12 (which may be referred to as an array of battery cells) that are arranged in series and installed in a battery cavity 14 of an electronic device 16 (such as a portable electronic device, a child toy, a flashlight, a portable radio, etc.). The battery cells 12 may comprise a primary alkaline electrochemical cell that includes a cathode, an anode, and a housing. The battery cell 12 also includes an end cap that serves as a negative terminal of the battery cell 12. A positive pip is located at the opposite end of the battery cell 12 from the end cap. The positive pip serves as a positive terminal of the battery cell 12. An electrolytic solution is dispersed throughout the battery cell 12. The battery cell 12 can be, for example, a AA, AAA, AAAA, C, or D alkaline battery.

The housing can be made of any suitable type of housing base material, for example cold-rolled steel or nickel-plated cold-rolled steel. The housing may have a cylindrical shape. The housing may have a sidewall including an interior surface that is treated with a material that provides a low electrical-contact resistance between the interior surface of the sidewall of the housing and an electrode, such as the cathode. The interior surface of the sidewall of the housing may be plated, e.g., with nickel, cobalt, and/or painted with a carbon-loaded paint to decrease contact resistance between, for example, the internal surface of the sidewall of the housing and the cathode.

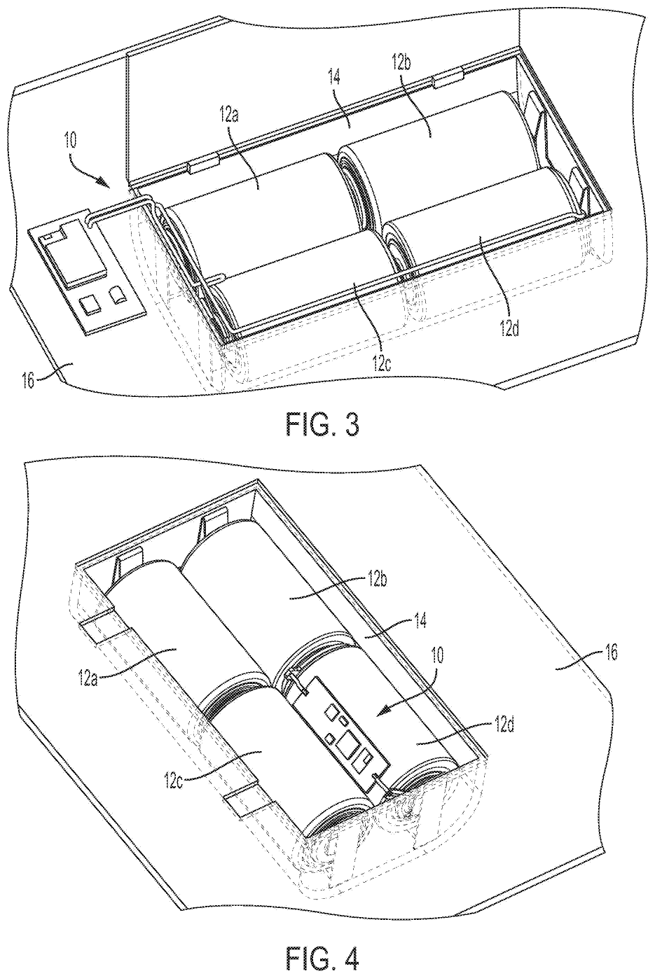

The magnetic battery cell connection mechanism 10 is illustrated connected to different battery cells 12a-d in the array in different figures in FIGS. 1-3. For example, in FIG. 1, the magnetic battery cell connection mechanism 10 is illustrated connected to a lower left battery cell 12c and to an upper left battery cell 12a in the array, thereby tapping current from four battery cells; in FIG. 2, the magnetic battery cell connection mechanism 10 is illustrated connected to the lower left battery cell 12c and to an upper right battery cell 12b, thereby tapping current from three battery cells; and in FIG. 3, the magnetic battery cell connection mechanism 10 is illustrated connected to the lower left battery cell 12c and to a lower right battery cell 12d, thereby tapping current from two battery cells. In this manner, the disclosed magnetic battery cell connection mechanism 10 is capable of generating electrical characteristic information, or of tapping electrical current, for any one or more battery cells and any combination of battery cells in a plurality of battery cells 12a-d. In any of the embodiments illustrated in FIGS. 1-3, an external load, such as an electronic module 30 that in some embodiments may comprise a battery indicator, may be located outside of the battery cavity 14, which may advantageously provide easy access to the electronic module 30.

FIG. 4 illustrates an alternate embodiment of a magnetic battery cell connection mechanism 10 that is connected to a single battery cell 12d. In the embodiment of FIG. 4, the electronic module 30 may be located within the battery cavity 14, but not interfering with the electrical connections between battery cells 12, which advantageously secures and protects the electronic module 30 within the battery cavity 14.

Each magnetic battery cell connection mechanism 10 in the embodiments of FIGS. 1-4 includes the external load or electronic module 30, a first or positive connector 32 and a second or negative connector 34. In other embodiments, the positive/negative relationship may be reversed so that the first connector is the negative connector 34 and the second connector is the positive connector 32. Regardless, the first and second connectors 32, 34 are electrically connected to the electronic module 30 with wires 36, 38. The positive connector 32 is electrically connected to a positive terminal 40 of a battery cell 12, while the negative connector is electrically connected to a negative terminal 42 of a battery cell 12, thereby allowing current to flow from the battery cells 12 to the electronic module 30.

The electronic module 30 may include an integrated circuit, which may be incorporated into a printed circuit board (PCB), which in some embodiments may comprise a multi-layered insulator/conductive structure that can be a rigid epoxy, FR4 phelonic with bonded copper traces, or a flexible polyester, polyamide with bonded copper traces. The electronic module 30 may also include an integrated circuit that comprises an embedded voltage sensor within the integrated circuit. The embedded voltage sensor senses analog characteristics of the battery cell 12, such as amperes and voltage, and converts the sensed analog characteristics to digital information. The electronic module 30 may also comprise a communication module, which may establish communications and exchange communication signals with a router, an endpoint, and/or a personal electronic device via one or more communicative connections. More particularly, the communication module includes one or more transceivers configured to transmit and/or receive signals, via the communication connections, with external devices. Communication signals to and/or from the communication module may include wireless signals (RF signals) or wired communication signals (e.g., via USB data connection). The communication module may also include one or more modems configured to convert signals that are received/transmitted, via the one or more transceivers, to signals that are interpreted by a processor and/or a PB app. The electronic module 30 and power bank may be communicatively connected via one or more communicative connections. The one or more communicative connections may include a wireless radio frequency (RF) connection (e.g., via Bluetooth Low Energy (BLE), Zigbee, Universal Plug n Play (UPnP), WiFi low Power, 6LoWPAN, and/or other suitable protocols). An antenna may be operatively coupled to the communication module. In some embodiments, the integrated circuit, may incorporate an analog to digital converter, a microcontroller, a Wi-Fi radio, a memory device, and/or a DC/DC voltage converter.

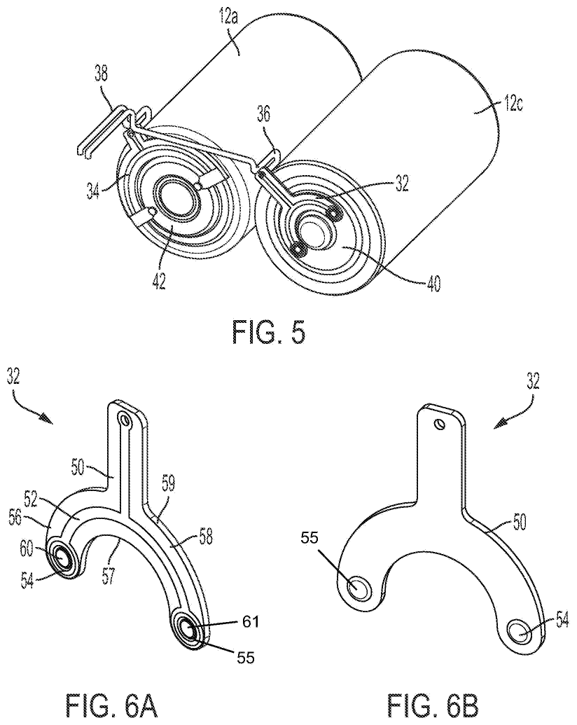

Turning now to FIG. 5, a close up perspective view of the top left battery cell 12a and the bottom left battery cell 12c is illustrated from FIG. 1. The top left battery cell 12a has the negative connector 34 electrically connected to the negative terminal 42. The bottom left battery cell 12c has the positive connector 32 electrically connected to the positive terminal 40. As illustrated in FIG. 5, the positive connector 32 is free to rotate around the positive terminal 40 without losing the electrical connection. Similarly, the negative connector 34 is free to rotate around the negative terminal 42 without losing the electrical connection. Furthermore, because the positive and negative connectors 32, 34 do not cover the top or bottom most parts of the positive and negative terminals 40, 42, the positive and negative connectors 32, 34 may be attached to the positive and negative terminals 40, 42, respectively, while the battery cells 12 are installed in an electronic device without interrupting electrical contact between the battery cell 12 and the contacts of the electronic device.

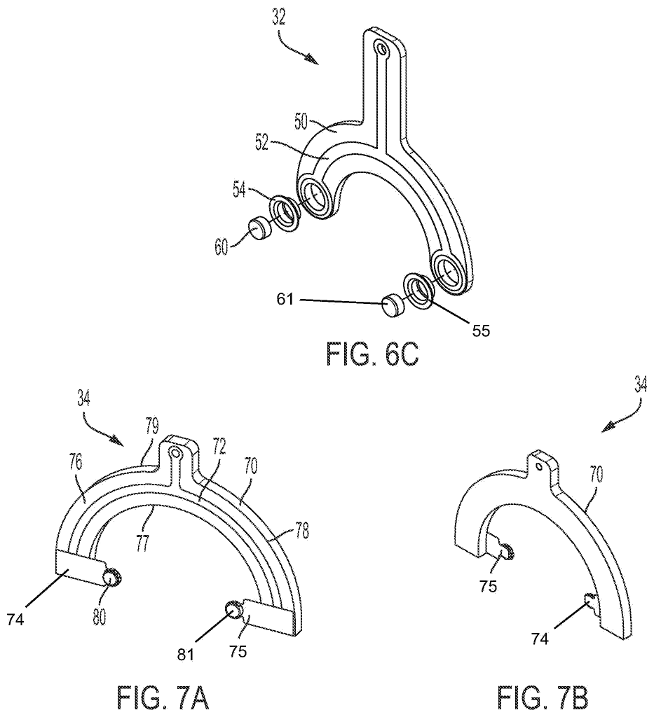

Turning now to FIGS. 6A-6C, the positive connector 32 has a first body 50 including a first electrical pathway 52. A first electrical contact 54 is disposed on the first body 50 and electrically connected to the first electrical pathway 54. The first electrical contact 54 is adapted to allow electricity to pass from the positive terminal 40 of the first battery cell 12 to the first electrical pathway.

The first body 50 may include a first arm 56 and a second arm 58 that diverge away from one another. In the embodiment illustrated in FIGS. 6A-6C, the first arm 56 and the second arm 58 form a y-shaped first body 50. In the embodiment illustrated in FIGS. 6A-6C, the y-shaped first body 50 includes an arc-shaped inner surface 57 and an arc-shaped outer surface 59 connecting the first arm 56 and the second arm 58. The arc-shaped inner surface 57 may include a radius that is substantially similar to the radius of the positive terminal 40. In other embodiments, the arc-shaped inner surface 57 may include a radius that differs from the radius of the positive terminal. In yet other embodiments, the first arm 56 and the second arm 58 may form a u-shape or a v-shape. In some embodiments, the first body 50 is provided by a printed circuit board (PCB).

A first magnet 60 is connected to the first body 50, the first magnet 60 being adapted to magnetically releasably secure the first body 50 to the positive terminal 40 of the first battery cell 12 and to establish contact between the positive terminal 40 of the first battery cell 12 and the first electrical pathway 52. In the embodiments of FIGS. 1-7, the first electrical contact 54 has a cup-shape, and the first magnet 60 is at least partially seated within a depression of the cup-shaped first electrical contact 54. The first magnet 60 may be held in place by magnetic attraction to the first electrical contact 54 or by an interference fit with the first electrical contact 54. In other embodiments, the first electrical contact 54 may include a through-hole and the first magnet 60 may be seated at least partially within the through-hole. In still other embodiments, the first magnet 60 and the first electrical contact 54 may be combined into a single unitary structure, or the first magnet 60 may also form the first electrical contact 54 by providing both magnetic attraction and electrical conductivity. In the embodiment illustrated in FIGS. 6A-6C, electrical contacts 54, 55 and magnets 60, 61 are disposed near terminal ends of first arm 56 and the second arm 58. In other embodiments, only one of the first arm 56 and the second arm 58 may include the first electrical contact 54 and the first magnet 60. In yet other embodiments, the first electrical contact 54 may be disposed on the first arm 56 and the first magnet 60 may be disposed on the second arm 58.

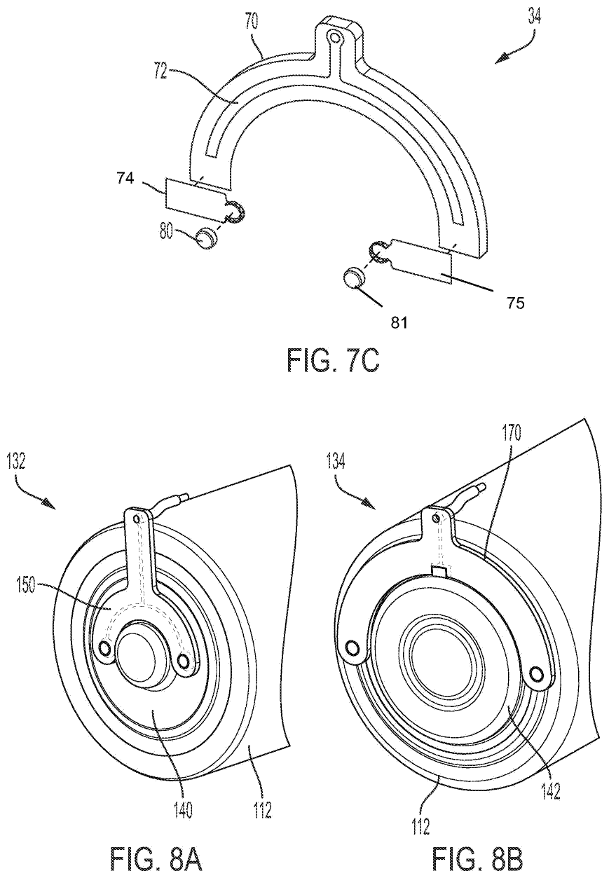

Turning now to FIGS. 7A-7C, the negative connector 34 has a second body 70 including a second electrical pathway 72. A second electrical 74 contact is disposed on the second body 70 and is electrically connected to the second electrical pathway 72. In the embodiment illustrated in FIGS. 7A-7C, the second electrical contact 74 takes the form of a rectangular contact plate, although the contact plate could have any shape and/or size that allows the contact plate to establish an electrical connection to a battery terminal. The second electrical contact 74 is adapted to allow electricity to pass from the negative terminal 42 of the second battery cell 12 to the second electrical pathway 72.

The second body 70 may include a first arm 76 and a second arm 78 that diverge away from one another. In the embodiment illustrated in FIGS. 7A-7C, the first arm 76 and the second arm 78 form a y-shaped second body 70. In the embodiment illustrated in FIGS. 7A-7C, the y-shaped second body 70 includes an arc-shaped inner surface 77 and an arc-shaped outer surface 79 connecting the first arm 76 and the second arm 78. The arc-shaped inner surface 77 may include a radius that is substantially similar to the radius of the negative terminal 42. In other embodiments, the arc-shaped inner surface 77 may include a radius that differs from the radius of the negative terminal. In yet other embodiments, the first arm 56 and the second arm 58 may form a u-shape or a v-shape. In some embodiments, the second body 70 is provided by a printed circuit board (PCB).

A second magnet 80 is connected to the second body 70, the second magnet 80 is adapted to magnetically releasably secure the second body 70 to the negative terminal 42 of the second battery cell 12 and to establish contact between the negative terminal 42 of the second battery cell 12 and the second electrical pathway 74. In the embodiments of FIGS. 1-7, the second electrical contact 74 includes a cup-shaped retaining element, and the second magnet 80 is at least partially seated within the cup-shaped retaining element of the second electrical contact 74. The second magnet 80 may be held in place by magnetic attraction to the second electrical contact 74 or by an interference fit with the second electrical contact 74. In other embodiments, the second electrical contact 74 may include a through-hole and the second magnet 80 may be seated at least partially within the through-hole. In still other embodiments, the second magnet 80 and the second electrical contact 74 may be combined into a single unitary structure, or the second magnet 80 may also form the second electrical contact 74 by providing both magnetic attraction and electrical conductivity. In the embodiment illustrated in FIGS. 7A-7C, electrical contacts 74, 75 and magnets 80, 81 are disposed near terminal ends of the first arm 76 and the second arm 78. In other embodiments, only one of the first arm 76 and the second arm 78 may include the second electrical contact 74 and the second magnet 80. In yet other embodiments, the second electrical contact 74 may be disposed on the first arm 76 and the second magnet 80 may be disposed on the second arm 78.

The positive connector 32 and the negative connector 34 are electrically connected to an electrical circuit, such as an electrical circuit provided by the electronic module 30, by the wires 36, 38 (FIGS. 1 and 5).

The first magnet 60 releasably secures the positive connector 32 to the positive terminal 40 of the first battery cell 12 by a magnetic attraction to the positive terminal 40. Similarly, the second magnet 81 releasably secures the negative connector 34 to the negative terminal 42 of the second battery cell 12 by a magnetic attraction to the negative terminal 42. In the illustrated embodiment, a plurality of first magnets 60, 61, and a plurality of second magnets 80, 81, provide symmetrical magnetic attraction to the positive terminal 40 and to the negative terminal 42, respectively, to enhance the electrical connections.

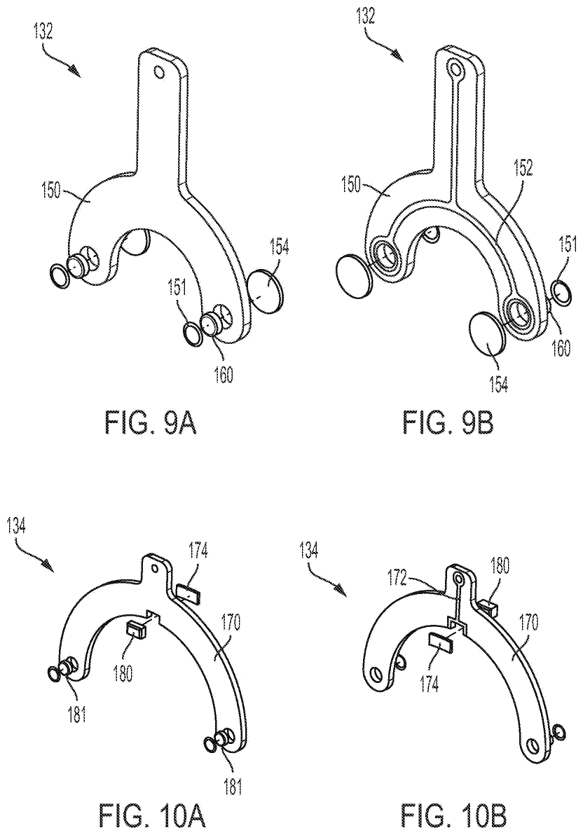

Turning now to FIGS. 8-10, alternate embodiments of first and second magnetic battery cell connectors 132, 134 are illustrated. In the embodiments illustrated in FIGS. 8-10, reference numbers are exactly 100 greater than the reference numbers for like elements of the embodiments illustrated in FIGS. 1-7. For example, the first or positive connector 132 in FIG. 8A is 100 greater than the first or positive connector 32 in FIG. 5. Any elements illustrated in the embodiment of FIGS. 8-10 may be combined with any element illustrated in the embodiment of FIGS. 1-7, and vice versa.

The positive connector 132 includes a first body 150 including a first electrical pathway 152. A first electrical contact 154 is electrically connected to the first electrical pathway 152. The first electrical contact 154 comprises a conductive plate. In some non-illustrated embodiments, the first electrical pathway 152 may comprise the first electrical contact 154, thereby eliminating the need for a separate conductive plate. In such embodiments, the first electrical pathway 152 faces the positive terminal 140 and directly contacts the positive terminal 140, thereby forming a direct electrical connection between the first electrical pathway 152 and the positive terminal 140. In such embodiments, the first electrical contact 154 is integrally formed with the first electrical pathway 152.

A first magnet 160 is disposed in an opening in the first body 150. When appropriately positioned, the first magnet 160 magnetically holds the first electrical contact 154 in contact with the first body 150, and thus in electrical contact with the first electrical pathway 154. The first magnet 160 also magnetically releasably secures the first body 150 to the positive terminal 140 of the first battery cell 112 by magnetizing the first electrical contact 154 and thus establishes contact between the positive terminal 140 of the first battery cell 112 and the first electrical pathway 152 through the first electrical contact 154. The first magnet 160 may be held in the opening in the first body 150 by a gasket 151 or similar element, such as an adhesive. In other embodiments, the first magnet 160 may form an interference fit in the opening in the first body 150, or an adhesive may secure the first magnet 160 in the opening.

The negative connector 134 includes a second body 170 including a second electrical pathway 172. A second electrical contact 174 is electrically connected to the second electrical pathway 172. The second electrical contact 174 comprises a conductive plate, such as a ferromagnetic plate. In some non-illustrated embodiments, the second electrical pathway 172 may comprise the second electrical contact 174, thereby eliminating the need for a separate conductive plate. In such embodiments, the second electrical pathway 172 faces the negative terminal 142 and directly contacts the negative terminal 142, thereby forming a direct electrical connection between the second electrical pathway 172 and the negative terminal 142. In such embodiments, the second electrical contact 174 is integrally formed with the second electrical pathway 172.

A second magnet 180 is disposed in an opening in the second body 170. When appropriately positioned, the second magnet 180 magnetically holds the second electrical contact 174 in contact with the second body 170, and thus in electrical contact with the second electrical pathway 172. The second magnet 180 also magnetically releasably secures the second body 170 to the negative terminal 142 of the battery cell 112 by magnetizing the second electrical contact 174 and thus establishes contact between the negative terminal 142 of the battery cell 112 and the second electrical pathway 172 through the second electrical contact 174. Optional securing magnets 161 may also be located at other positions on the second body 170 top aid in retention to the negative terminal 142. The embodiment of FIGS. 10A and 10B may provide particularly advantageous magnetic connection to the negative terminal 142 when the battery cell 112 has an insulating battery label that impedes magnetic electrical connections on the face of the negative terminal because the second magnet is magnetically attracted to the raised annular surface of the negative terminal as well as to the flat disc-shaped surface of the negative terminal. The second magnet 180, which may comprise an arc-shaped magnet, also provides an electrical connection on the raised annular edge of the negative terminal 142.

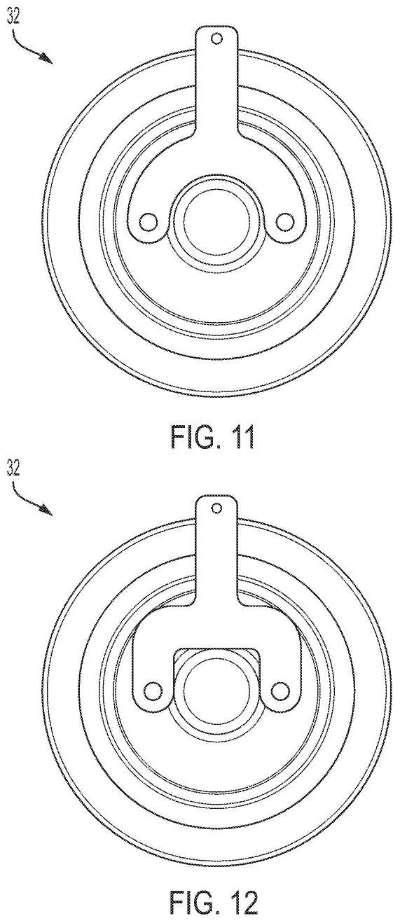

FIGS. 11 and 12 illustrate alternative shapes for the positive connector 32. The electrical pathways in FIGS. 11 and 12 are omitted for clarity. Similar alternative body shapes may be used for the negative connector 34.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A magnetic battery cell connector comprising:
a body having a first arm and a second arm that diverge away from one another, and an electrical pathway;
an electrical contact located proximate a terminal end of one of the first arm and the second arm, the electrical contact being electrically connected to the electrical pathway, the electrical contact being adapted to allow electricity to pass from a battery cell terminal to the first electrical pathway; and
a magnet at least partially seated in the electrical contact, the magnet being adapted to magnetically releasably secure the first body to the battery cell.

2. The magnetic battery cell connector of claim 1, wherein the first and second arms form an arc-shape.

3. The magnetic battery cell connector of claim 2, wherein an inner radius of the arc-shape is substantially the same as a battery end cap of a battery cell.

4. The magnetic battery cell connector of claim 1, wherein the electrical contact is cup-shaped and the magnet is at least partially seated in the electrical contact.

5. The magnetic battery cell connector of claim 1, further comprising a first contact plate at the end of the first arm and the magnet is disposed on the first contact plate.

6. The magnetic battery cell connector of claim 5, further comprising a second contact plate at the end of the second arm.

7. The magnetic battery cell connector of claim 1, wherein the body comprises a printed circuit board (PCB).

8. The magnetic battery cell connector of claim 1, wherein the first and second arms form one of a u-shape or a v-shape.

9. The magnetic battery cell connector of claim 1, wherein the electrical contact comprises a through-hole.

10. The magnetic battery cell connector of claim 9, wherein the magnet is seated at least partially within the through-hole.

11. The magnetic battery cell connector of claim 1, wherein the magnet and the electrical contact comprise a unitary structure.

12. The magnetic battery cell connector of claim 1, wherein the electrical contact is a first electrical contact, and further comprising a second electrical contact, the second electrical contact being electrically connected to the electrical pathway, the second electrical contact being adapted to allow electricity to pass from a battery cell terminal to the electrical pathway.

13. The magnetic battery cell connector of claim 12, wherein the magnet is a first magnet, and further comprising a second magnet at least partially seated in the second electrical contact, the second magnet being adapted to magnetically releasably secure the body to a battery cell.

14. The magnetic battery cell connector of claim 13, wherein the second electrical contact is a through-hole.

15. The magnetic battery cell connector of claim 14, wherein the second magnet is seated at least partially within the through-hole.

16. The magnetic battery cell connector of claim 13, wherein the second magnet and the second electrical contact comprise a unitary structure.

17. The magnetic battery cell connector of claim 1, further comprising an electrical connection to an electronic module.

18. The magnetic battery cell connector of claim 17, wherein the electronic module comprises an integrated circuit.

19. The magnetic battery cell connector of claim 18, wherein the electronic module further comprises an embedded voltage sensor.

20. The magnetic battery cell connector of claim 18, wherein the electronic module further comprises a communication module.
